(19) United States
(12) Patent Application Publication
(10) Pub. No.: US 2022/0122000 A1
(43) Pub. Date: Apr. 21, 2022

(54) ENSEMBLE MACHINE LEARNING MODEL

(71) Applicant: International Business Machines Corporation, Armonk, NY (US)

(72) Inventors: Jia Qi Li, Beijing (CN); Li Zhang, Beijing (CN); Jun Ying Lu, Beijing (CN); Fan Jing Meng, BEIJING (CN); Shi Lei Zhang, Beijing (CN)

(21) Appl. No.: 17/073,581

(22) Filed: Oct. 19, 2020

(51) Int. Cl. G06N 20/20; G06K 9/62

(52) U.S. Cl. CPC G06N 20/20; G06K 9/6215; G06K 9/623; G06K 9/6262; G06K 9/6202

(57) ABSTRACT

Described are techniques for using a dynamic ensemble model. The techniques including training a plurality of machine learning models on training data. The techniques further include identifying a similar subset of the training data that is similar to a dataset for evaluation. The techniques further include assembling a subset of models from the plurality of machine learning models based on performance of the subset of models on the similar subset of the training data. The techniques further include generating an output from the subset of models for the dataset for evaluation.

### BACKGROUND

The present disclosure relates to machine learning, and, more specifically, to a dynamic ensemble machine learning model.

Machine learning is a subset of artificial intelligence that involves the utilization of computer algorithms capable of learning tasks. One application of machine learning is in anomaly detection. Anomaly detection, also referred to as outlier detection, can refer to the identification of rare observations, events, or data that may be indicative of a current or future undesirable event (e.g., a hardware failure, a security breach, etc.). Anomaly detection can be used in fields such as, but not limited to, computer monitoring, network monitoring, industrial control systems, manufacturing systems, threat detection systems, failure detection system, and/or other fields.

### SUMMARY

Aspects of the present disclosure are directed toward a computer-implemented method comprising training a plurality of machine learning models on training data. The method further comprises identifying a similar subset of the training data that is similar to a dataset for evaluation. The method further comprises assembling a subset of models from the plurality of machine learning models based on performance of the subset of models on the similar subset of the training data. The method further comprises generating an output from the subset of models for the dataset for evaluation.

Further aspects of the present disclosure are directed toward a computer-implemented method comprising generating a training matrix including features for each of a plurality of training data and generating a model results matrix including outputs from a plurality of models for each of the plurality of training data. The method further comprises generating a scoring matrix by applying a sigmoid function to the model results matrix to generate a plurality of model scores for each of the plurality of training data. The method further comprises generating a ground truth matrix including a ground truth score based on the plurality of model scores for each of the plurality of training data and selecting a similar subset of training data that is similar to a dataset for evaluation. The method further comprises selecting, based on the scoring matrix and the ground truth matrix, a subset of models from the plurality of models with performance above a threshold for the similar subset of training data. The method further comprises generating an output from the subset of models for the dataset for evaluation.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example dynamic ensemble model, in accordance with some embodiments of the present disclosure.

FIG. 2 illustrates a flowchart of an example method for utilizing a dynamic ensemble model, in accordance with some embodiments of the present disclosure.

FIG. 3 illustrates various example matrices related to establishing a ground truth for each training data from a plurality of models, in accordance with some embodiments of the present disclosure.

FIG. 4 illustrates various example matrices related to selecting a subset of models with adequate performance on a similar subset of the training data that is similar to a dataset for evaluation, in accordance with some embodiments of the present disclosure.

FIG. 5 illustrates a flowchart of an example method for utilizing a dynamic ensemble model using various matrices, in accordance with some embodiments of the present disclosure.

FIG. 6 illustrates a block diagram of an example computer, in accordance with some embodiments of the present disclosure.

FIG. 7 depicts a cloud computing environment, in accordance with some embodiments of the present disclosure.

FIG. 8 depicts abstraction model layers, in accordance with some embodiments of the present disclosure.

While the present disclosure is amenable to various modifications and alternative forms, specifics thereof have been shown by way of example, in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward machine learning, and, more specifically, to a dynamic ensemble machine learning model. While not limited to such applications, embodiments of the present disclosure may be better understood in light of the aforementioned context.

A primary challenge of using machine learning for anomaly detection relates to imbalanced training data. In other words, training data includes relatively few anomalous events relative to expected or typical events due to the nature of anomalies. Imbalanced training data can make it difficult to accurately train a machine learning algorithm.

One strategy to address the challenges of imbalanced training data as it relates to machine learning is to use an ensemble of machine learning models. An ensemble of machine learning models utilizes two or more machine learning models trained on the training data, where each of the machine learning models is trained according to different techniques, algorithms, or hyperparameters. New data can be input to the ensemble of trained machine learning models, and the output of the ensemble of trained machine learning models can be the average output of all the trained machine learning models (or, alternatively, a most common output of the trained machine learning models). Ideally, a majority of machine learning models within the ensemble of trained machine learning models will perform adequately and outweigh any poorly performing machine learning models within the ensemble of trained machine learning models.

However, aspects of the present disclosure recognize that each machine learning model of an ensemble of machine learning models performs best on a distinct subset of the training data. In other words, different types of machine learning models perform better or worse on different portions of training data. Accordingly, aspects of the present disclosure are directed toward selecting a subset of machine learning models from a plurality of machine learning models for evaluating new data. The subset of machine learning models can be selected by determining that the subset of machine learning models performed better than other machine learning models on a portion of the training data that is similar to the new data. Advantageously, selecting a subset of machine learning models based on local performance of the subset of machine learning models that is similar to the new data can result in improved accuracy of the output of the subset of machine learning models relative to an ensemble of machine learning models that does not account for local performance.

Furthermore, some embodiments of the present disclosure are directed to techniques for intelligently identifying a similar subset of the training data that is similar to the new data for evaluation. Aspects of the present disclosure can utilize both a distance metric and a relative density metric in identifying the similar subset of the training data. The distance metric can be used to identify data points that are similar to data in the new data, and the relative density metric can be utilized to ensure a diverse variety of similar data is selected. Collectively, the use of both a distance metric and a relative density metric can result in selection of a better performing subset of machine learning models insofar as the distance metric identifies relevant training data for the similar subset of training data and the relative density metric ensures a sufficient diversity of the relevant training data is selected. Sufficient diversity ensures that a variety of features can be accounted for when selecting an appropriate subset of machine learning models.

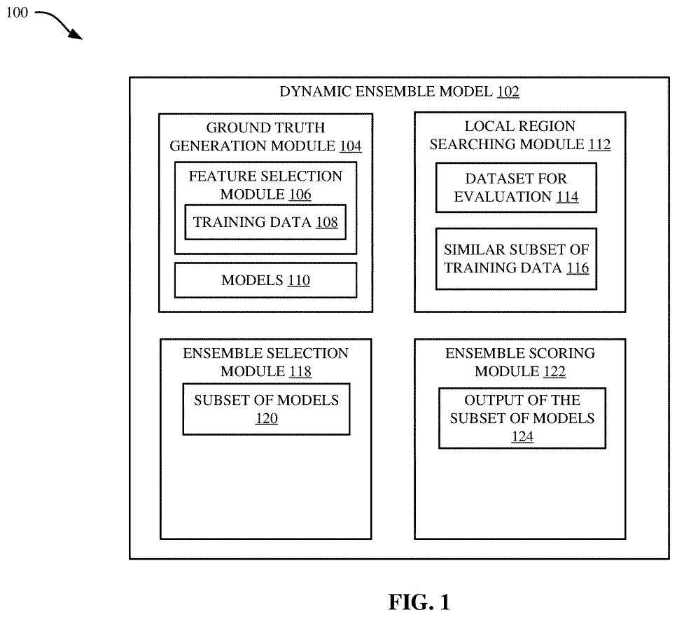

Referring now to FIG. 1, illustrated is a computational environment 100 including a dynamic ensemble model 102. The dynamic ensemble model 102 includes a ground truth generation module 104, a local region searching module 112, an ensemble selection module 118, and an ensemble scoring module 122. Each of the aforementioned modules can be a set of processor-executable programming instructions configured to generate, store, and/or transmit data and/or otherwise implement the functionality discussed hereafter.

The ground truth generation module 104 includes a feature selection module 106 configured to identify salient features of the training data 108 using feature selection techniques now known or later developed. The ground truth generation module 104 can further include models 110. The models 110 can refer to any type of machine learning models using any number of machine learning algorithms. Machine-learning algorithms can include, but are not limited to, decision tree learning, association rule learning, artificial neural networks (ANN), recurrent neural networks (RNNs), deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques. In various embodiments, the models 110 include a similar type of model with varied hyperparameters, different types of models, or a combination of both. Each of the models 110 can be trained on the training data 108.

The local region searching module 112 can be configured to receive a dataset for evaluation 114. Dataset for evaluation 114 can be batched data or real-time data received from, for example, another data processing system (not shown) via a network (not shown). The local region searching module 112 can be configured to match the dataset for evaluation 114 to a similar subset 116 of the training data 108. In some embodiments, the similar subset 116 of the training data 108 can be defined as a subset of training data 108 that is similar to one or more objects in the dataset for evaluation 114. In some embodiments, both a distance metric and a relative density metric are used to select the similar subset 116 of the training data 108. The distance metric can quantify how similar one or more training data are to the dataset for evaluation 114. The distance metric can utilize algorithms such as, but not limited to, KNN, clustering, and the like. Thus, the distance metric can be used to ensure that each data point in the similar subset 116 of the training data 108 is sufficiently similar to one or more data points in the dataset for evaluation 114. In contrast, the relative density metric can be used to ensure that diverse data points are utilized in the similar subset 116 of the training data 108. Said another way, the relative density metric can be used to decrease the density of data points in the similar subset 116 (so that the density of data points in the similar subset 116 is similar to, or less than, a threshold such as a density of data points in the training data 108 or a density of data points in the dataset for evaluation 114). In some embodiments, the relative density metric can quantify how close data points in the similar subset 116 of the training data 108 are to each other. In some embodiments, the relative density metric can quantify how dense the similar subset 116 is relative to the training data 108 and/or the dataset for evaluation 114. Advantageously, utilizing the relative density metric in combination with the distance metric facilitates a diverse aggregation of relevant data points in the similar subset 116.

The ensemble selection module 118 can be configured to assemble an ensemble of models which is illustrated in FIG. 1 as a subset of models 120. The subset of models 120 can be those models that exhibit adequate (e.g., above a threshold) or relatively-better (e.g., compared to other models) performance on the similar subset 116 of the training data 108. The subset of models 120 can include a number of models, where the number of models can be between two models and one fewer than the plurality of models 110, inclusive. The subset of models 120 can be selected by relative ranking, absolute performance, or a combination of both. When using relative ranking, a predetermined number of highest performing models can be selected for the subset of models 120. For example, a first place (highest ranking) model, a second place (second highest ranking) model, and a third place (third highest ranking) model for performance on the similar subset 116 of the training data 108 can be assembled into the subset of models 120. When using absolute performance, any model of the plurality of models 110 that exhibited performance above a threshold accuracy level on the similar subset 116 of the training data 108 can be included in the subset of models 120. For example, if the threshold level of accuracy is 95%, then any of the models 110 that exhibited accuracy at or above 95% for the similar subset 116 of the training data 108 can be assembled into the subset of models 120.

The ensemble scoring module 122 can include the output 124 of the subset of models 120. The ensemble scoring module 122 can be configured to provide the dataset for evaluation 114 to the subset of models 120 and receive the output 124 of the subset of models 120 in response to the subset of models 120 ingesting the dataset for evaluation 114. The output 124 of the subset of models 120 can be, for example, the averaged output of each of the subset of models 120, a weighted averaged output of each of the subset of models 120, a most frequent output of the subset of models 120, or an output generated using another statistical technique for converting the outputs of each of the models in the subset of models 120 into a final output. When using a weighted average, the weights applied to the respective models in the subset of models 120 can be based on a performance or accuracy of each of the models on the similar subset 116 such that higher performing or more accurate models are weighted relatively higher than lower performing or less accurate models in the subset of models 120.

Advantageously, output 124 can exhibit improved accuracy relative to traditional ensemble models. For example, output 124 using the subset of models 120 can exhibit improved accuracy compared to another output from the plurality of models 110 for a same set of ingested data (e.g., dataset for evaluation 114). This improved performance is a result of selecting the subset of models 120 that perform best for the type of data contained in the dataset for evaluation 114. In other words, by excluding poorly performing models from the plurality of models 110 given the characteristics of the dataset for evaluation 114, aspects of the present disclosure can reduce the negative influence of models that may generally perform well, but perform poorly in a local region such as the local region associated with the dataset for evaluation 114. Conversely, aspects of the present disclosure enhance the positive influence of models that performed relatively better in the local region. Collectively, by assembling the subset of models 120 based on local performance similar to the dataset for evaluation 114, aspects of the present disclosure realize improved accuracy in the output 124.

The output 124 can be used to identify anomalous data in the dataset for evaluation 114, classify data in the dataset for evaluation 114, or otherwise provide evaluative indications associated with the dataset for evaluation 114. In some embodiments, the output 124 is converted to a user-consumable data object that can be presented on a user interface (not shown) of a data processing system (not shown), such as a user console. In some embodiments, the output 124 is converted to text, a graph, or another infographic providing significance to a user. In some embodiments, the output 124, or any user-consumable data objects derived therefrom, is transmitted to a remote server (not shown), a user device (not shown), or another system by a network (not shown). In some embodiments, the output 124, or any user-consumable data objects derived therefrom, is stored in the dynamic ensemble model 102.

The dynamic ensemble model 102 can be incorporated into a computer, server, or other data processing system having a memory storing executable instructions and a processor capable of executing the executable instructions. In some embodiments, the dynamic ensemble model 102 is stored in a same physical or virtual data processing architecture that generates the dataset for evaluation 114 (e.g., as an anomaly detection system residing within a computer it is safeguarding). In other embodiments, the dynamic ensemble model 102 is stored remote from the physical or virtual data processing architecture generating the dataset for evaluation 114. In such embodiments, the dynamic ensemble model 102 can be delivered as a service.

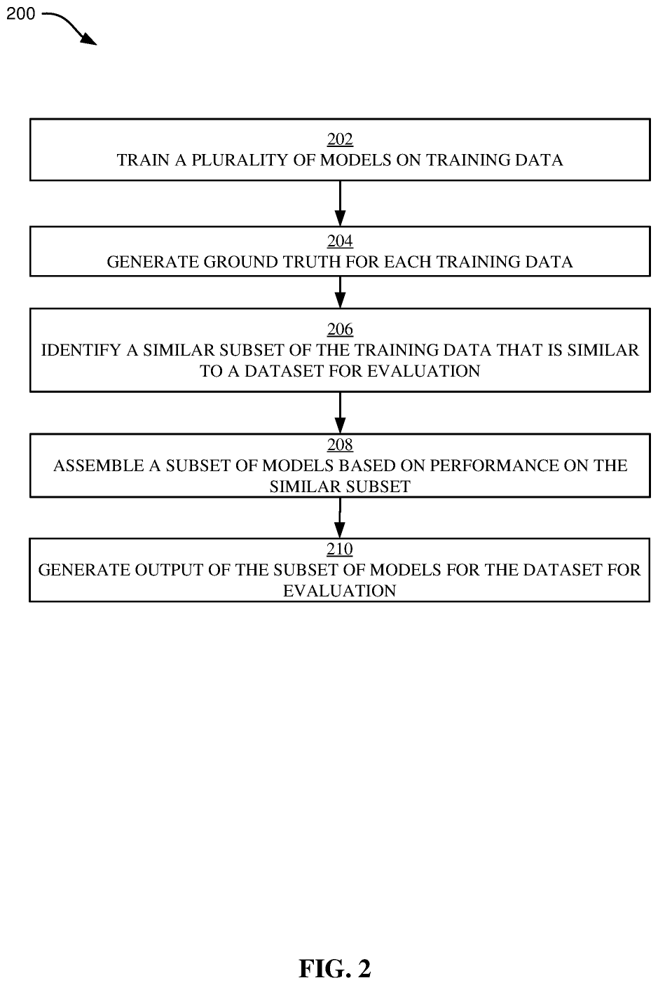

FIG. 2 illustrates a flowchart of an example method 200 for generating and using a dynamic ensemble model 102, in accordance with some embodiments of the present disclosure. The method 200 can be implemented by, for example, a computer, a processor, a server, a data processing system, the dynamic ensemble model 102 of FIG. 1, or another combination of hardware and/or software.

Operation 202 includes training a plurality of models 110 on training data 108. As previously discussed, the plurality of models 110 can be similar or dissimilar types of machine learning models. In embodiments where the plurality of models 110 utilize similar algorithms or techniques, each of the plurality of models 110 can include distinct hyperparameters that respectively tune each model's performance.

Operation 204 includes generating a ground truth for each of the training data 108. Operation 204 can thus involve evaluating the output of each of the plurality of models 110 for each data point of the training data 108 and determining, from the aggregated output, a ground truth for each data point of the training data 108. A ground truth can be a binary (e.g., 0 or 1, anomalous or non-anomalous, etc.), a multi-choice classification, or another numeric or lexical output.

Operation 206 includes identifying a similar subset 116 of the training data 108 that is similar to a received dataset for evaluation 114. As previously discussed, a distance metric and a relative density metric can be utilized in order to include a sufficiently diverse and sufficiently similar set of data points in the similar subset 116.

Operation 208 includes assembling a subset of models 120 based on performance of the subset of models 120 on the similar subset 116. In some embodiments, the subset of models 120 includes a predetermined number of highest-ranking models, any number of models performing above a threshold accuracy, or models satisfying some combination of ranking and threshold accuracy.

Operation 210 includes generating an output 124 of the subset of models 120 for the dataset for evaluation 114. The output 124 can be an averaged output of each of the models in the subset of models 120, a most common output of each of the models in the subset of models 120, or a different method capable of statistically aggregating the outputs of the subset of models 120 into a single output 124.

Although not explicitly shown, operation 210 can further include converting the output 124 to a user-consumable data object such as, for example, an indication of an anomaly, a classification, or another user-consumable data object. In such embodiments, operation 210 can further include transmitting, storing, and/or displaying any user-consumable data object derived from the output 124.

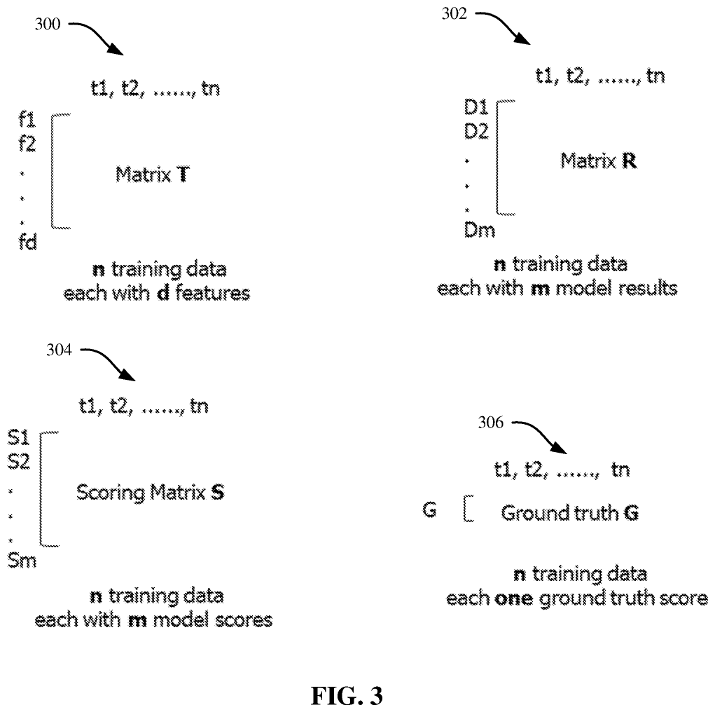

FIG. 3 illustrates matrices associated with establishing ground truths, in accordance with some embodiments of the present disclosure. Training matrix T 300 represents training data 108 which can include n training data (e.g., t1, t2, . . . , tn), where each training data is associated with d features (f1, f2, . . . , fd). Model results matrix R 302 represents a result for each training data 108 for each model in the plurality of models 110. In other words, model results matrix R 302 includes n training data (e.g., t1, t2, . . . , tn), where each training data is associated m model results (e.g., D1, D2, . . . , Dm). Scoring matrix S 304 represents a score, such as a normalized score (e.g., a score between 0 and 1, inclusive). In some embodiments, scoring matrix S 304 utilizes a sigmoid function to generate the normalized scores. In some embodiments, the scoring matrix S 304 uses a confidence of a result together with the result in determining a score. The scoring matrix S 304 n training data (e.g., t1, t2, . . . , tn), where each training data is associated with m scores (S1, S2, . . . , Sm), each of the m scores representing a score corresponding to a matrix result.

Ground truth matrix G 306 includes a single ground truth (e.g., G) for each training data 108 (e.g., t1, t2, . . . , tn). The Ground truth matrix G 306 can be based on information in the scoring matrix S 304. For example, the ground truth matrix G 306 can include an average score in scoring matrix S 304, a most frequent score (or classification) in scoring matrix S 304, or a result of another statistical measure useful for converting multiple scores for each training data into a single ground truth. In some embodiments, for each training data n, the ground truth of m models is determined according to Equation 1:

Gₙ=sigmoid(−Σ_{d=1}^{m}Sₙ^{d} log Sₙ^{d}) Equation 1:

In other words, Equation 1 can be used to determine the ground truth Gₙ as the sigmoid function applied to the negative sum of each score of each model for the training data n multiplied by the log of each score of each model for the training data n.

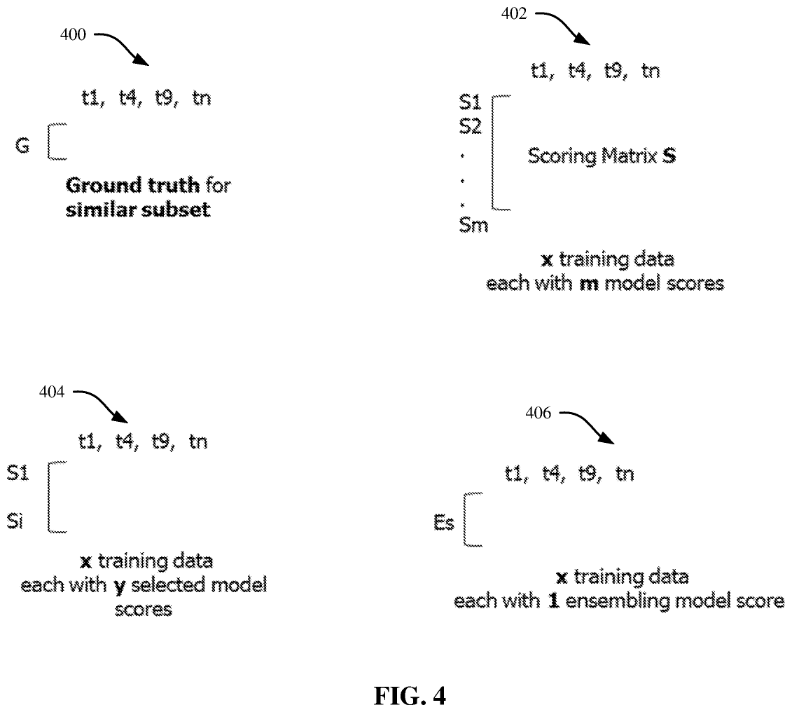

FIG. 4 illustrates matrices associated with establishing an output 124 from a subset of models 120 for a similar subset 116, in accordance with some embodiments of the present disclosure. First, once the similar subset 116 is identified, the ground truth for each data point in the similar subset 116 can be collected as shown in matrix 400. As previously discussed, the similar subset 116 can be based on a distance metric and a relative density metric. For example, the similar subset 116 can be derived according to Equation 2:

$$s i m ( i , j ) = \frac{relative\_density ( i , j )}{relative\_distance ( i , j )} = \frac{\frac{density ( i , k )}{( Σ density ( j , k ) / \vert N ( i , k ) \vert )}}{distance ( i , j )} \qquad Equation 2$$

In Equation 2, the similarity (sim) between one or more i data points in the training data 108 and one or more j data points in the dataset for evaluation 114 can be based on the relative density divided by the relative distance for the two data points. A high score can indicate a higher degree of similarity.

The distance metric can determine a distance between one or more points i in the training data 108 and one or more points j in the dataset for evaluation 114. A lower distance can indicate a higher degree of similarity, whereas a larger distance can indicate less similarity.

The relative density metric can be a ratio of the density of the training data 108 to the density of the dataset for evaluation 114. A relatively larger relative density metric can indicate a relatively less dense dataset for evaluation 114 compared to the training data 108 which is desirable in accordance with some embodiments of the present disclosure.

As shown in matrix 400, the similar subset 116 includes four data points (t1, t4, t9, and tn). However, this is only an example, and more or fewer data points can be included in the similar subset 116. Next, the scores from the scoring matrix S (e.g., scoring matrix S 304 of FIG. 3) for each of the data points in the similar subset 116 can be collected as shown in Matrix 402. Matrix 400 together with matrix 402 can be used to select the subset of models 120 from the plurality of models 110. More specifically, a predetermined number of highest-ranking models (e.g., those with the highest-ranking scores consistent with the corresponding ground truth), can be aggregated into the subset of models 120. Alternatively, or in addition, any number of models with an accurate score exceeding a threshold can be aggregated into the subset of models 120. Further, in some embodiments, an algorithm can be used to quantify the accuracy of a given model for the similar subset 116 as shown in Equation 3:

$$d ( G , S ) = {\sum }_{k = 1}^{y} ( {G}_{k} - {S}_{k} ) log \frac{{G}_{k}}{{s}_{k}} \qquad Equation 3$$

In other words, Equation 3 calculates, for a given model d, with a known ground truth G and score S for each data point y in the similar subset 116, the cumulative difference between the ground truth and the score multiplied by the log of the ground truth divided by the score for each data point in the similar subset 116.

Regardless of the mechanism by which the subset of models 120 is selected, the subset of models 120 is illustrated in matrix 404 where models S1 and Si are selected. Although matrix 404 shows two selected models in the subset of models 120, this is only an example, and any number of models between two models and one fewer than the plurality of models 110 can be selected as the subset of models 120. Matrix 406 illustrates the aggregation of scores from the subset of models 120 into a single output (e.g., ensemble score Es) for each training data in the similar subset 116. For example, the scores from the subset of models 120 can be compiled in an average, a weighted average, a most common score (or classification), or other methods now known or later developed for converting multiple scores from multiple models into a single score.

In some embodiments, the ensemble score (as shown in matrix 406) can be a weighted average, and each weight can be determined based on a performance of each of the subset of models 120 on the similar subset 116. For example, Equation 3 can be normalized relative to each of the subset of models 120 according to Equation 4:

weightᵢ=normalized(d(G,S)) Equation 4:

Subsequently, the ensemble score (as shown in matrix 406) can be determined by the cumulative multiplication of the weight multiplied by the score for respective data points in the similar subset 116 for each model in the subset of models 120 as shown in Equation 5:

Eₜⁱ=Σₜ₌₁^{Y}weightₜⁱ×Sₜⁱ Equation 5:

Although not explicitly shown, the dataset for evaluation 114 can be input to the subset of models 120 similar to matrix 404 (although instead of the similar subset 116 across the top of matrix 404, the dataset for evaluation 114 would extend across the top of matrix 404). Similarly, the scores of the subset of models 120 for the dataset for evaluation 114 can be aggregated together to generate an output 124 similar to matrix 406 (where, again, the dataset for evaluation 114 would extend across the top of matrix 406 rather than the similar subset 116).

In some embodiments, the scores are further manipulated to account for temporal and/or trending factors as shown in Equation 6:

$$S ( j ) = \frac{{Σ}_{i ∈ φ} s i m ( i , j ) \times {Score}_{i}}{{Σ}_{i ∈ φ} \vert sim ( i , j ) \vert} \times f ( i , j ) \times ∇ ( i ) \qquad Equation 6$$

As shown in Equation 6, a classification score S(j) can be calculated by summing a similarity (e.g., Equation 2) multiplied by a score (e.g., Equation 3 or 4) divided by the absolute value of the summed similarity. This result can be multiplied by a temporal relevance f (i, j) and a trending factor ∇(i).

Equation 7 can be used to determine a temporal relevance f (i, j):

f(i,j)=exp(−λ×|tᵢ−tⱼ|) Equation 7:

In Equation 7, the temporal relevance f (i, j) can be calculated by the exponent of −λ multiplied by an absolute value of a time step tᵢ−tⱼ. The term λ can be a user-defined parameter with temporal significance.

Equation 8 can be used to determine a trending factor ∇(i):

$$∇ ( i ) = {\sum }_{ɛ = 1}^{W} \frac{{E}_{t}^{i} - {E}_{t - ɛ}^{i}}{ɛ} \qquad Equation 8$$

In Equation 8, the trending factor ∇(i) can be calculated by differences in consecutive ensemble scores (e.g., Equation 5) divided by a term ε. The term ε can be a user-defined parameter useful for identifying and/or quantifying trends.

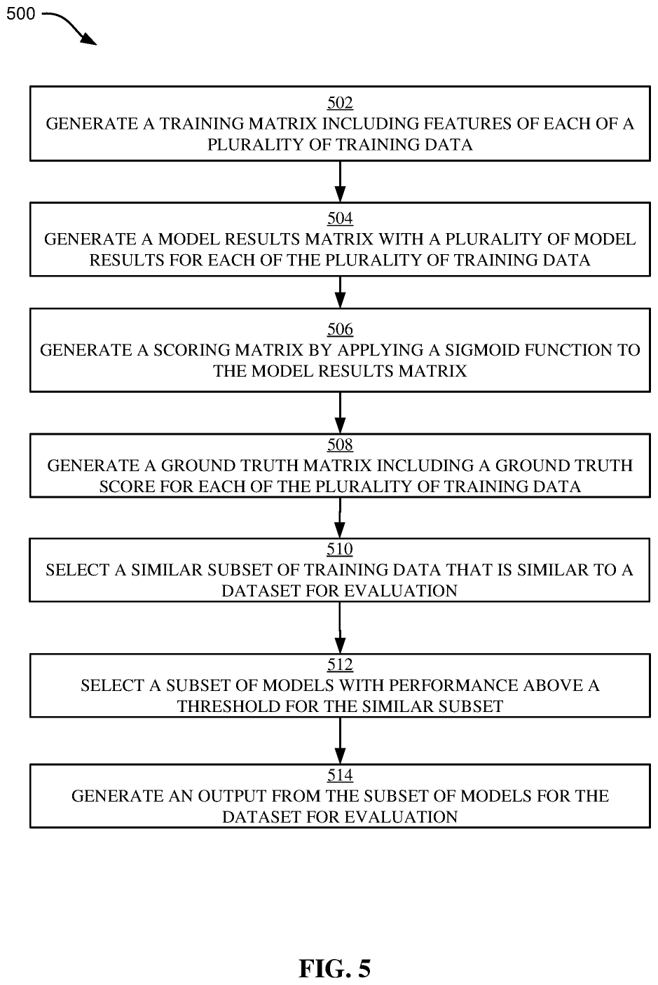

Referring now to FIG. 5, illustrated is a flowchart of an example method 500 for generating and applying a dynamic ensemble model 102 based on various matrices, in accordance with some embodiments of the present disclosure. The method 500 can be implemented by, for example, a computer, a processor, a server, a data processing system, the dynamic ensemble model 102 of FIG. 1, or another combination of hardware and/or software.

Operation 502 includes generating a training matrix T 300 including features of each of a plurality of training data 108. The features can be selected according to any feature selection methodology now known or later developed. Operation 504 includes generating a model results matrix R 302 including a plurality of model results from a plurality of models 110 for each of the plurality of training data 108. Operation 506 includes generating a scoring matrix S 304 by applying a sigmoid function to the model results matrix R 302. The sigmoid function can be configured to normalize the model outputs to a range between 0 and 1, inclusive.

Operation 508 includes generating a ground truth matrix G 306 including a ground truth score for each of the plurality of training data 108. The ground truth can be based on the plurality of model results for each of the plurality of training data 108 as retrieved from the scoring matrix S 304.

Operation 510 includes selecting a similar subset 116 of the plurality of training data 108 that is similar to a dataset for evaluation 114. Operation 510 can include identifying data in the similar subset 116 as data that exhibits a relatively lower distance to the dataset for evaluation 114 (relative to other data in the training data 108). Operation 510 can further include identifying data in the similar subset 116 as data that collectively exhibits a density below a threshold.

Operation 512 includes selecting a subset of models 120 with performance above a threshold accuracy for the similar subset 116 of the training data 108. Operation 512 can include collecting information from model scores matrix S 304 and/or ground truth matrix G 306 in characterizing an accuracy of various models in the plurality of models 110 with respect to the similar subset 116 of the plurality of training data 108.

Operation 514 includes generating an output 124 from the subset of models 120 for the dataset for evaluation 114. In some embodiments, the output 124 is a weighted average of each output of each of the subset of models 120. For example, respective models in the subset of models 120 can be weighted according to a respective score accuracy from the scoring matrix S 304 and/or the ground truth matrix G 306 for the similar subset 116 of the plurality of training data 108.

Although not explicitly shown, operation 514 can further include converting the output 124 to a user-consumable data object such as, for example, an indication of an anomaly, a classification, or another user-consumable data object. In such embodiments, operation 514 can further include transmitting, storing, and/or displaying any user-consumable data object derived from the output 124.

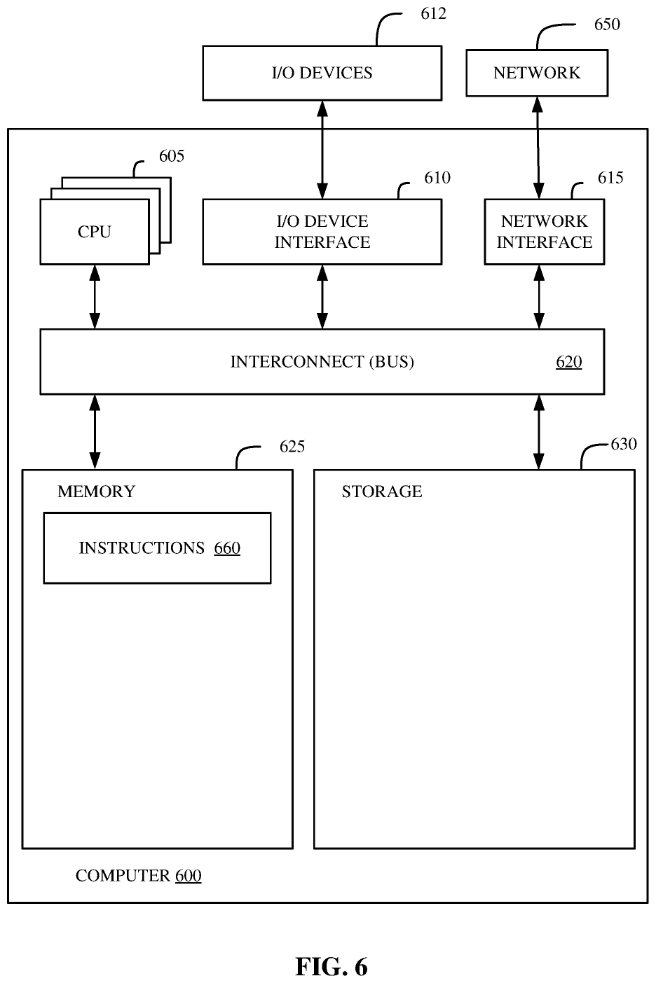

FIG. 6 illustrates a block diagram of an example computer 600 in accordance with some embodiments of the present disclosure. In various embodiments, computer 600 can perform any or all portions of the methods described with reference to FIGS. 2 and 5 and/or implement the functionality discussed with reference to one or more of FIGS. 1 and/or 3-4. In some embodiments, computer 600 receives instructions related to the aforementioned methods and functionalities by downloading processor-executable instructions from a remote data processing system via network 650. In other embodiments, computer 600 provides instructions for the aforementioned methods and/or functionalities to a client machine such that the client machine executes the method, or a portion of the method, based on the instructions provided by computer 600. In some embodiments, the computer 600 is incorporated into (or functionality similar to computer 600 is virtually provisioned to) one or more entities of the computational environment 100 (e.g., dynamic ensemble model 102) and/or other aspects of the present disclosure.

Computer 600 includes memory 625, storage 630, interconnect 620 (e.g., BUS), one or more CPUs 605 (also referred to as processors herein), I/O device interface 610, I/O devices 612, and network interface 615.

Each CPU 605 retrieves and executes programming instructions stored in memory 625 or storage 630. Interconnect 620 is used to move data, such as programming instructions, between the CPUs 605, I/O device interface 610, storage 630, network interface 615, and memory 625. Interconnect 620 can be implemented using one or more busses. CPUs 605 can be a single CPU, multiple CPUs, or a single CPU having multiple processing cores in various embodiments. In some embodiments, CPU 605 can be a digital signal processor (DSP). In some embodiments, CPU 605 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 625 is generally included to be representative of a random-access memory (e.g., static random-access memory (SRAM), dynamic random-access memory (DRAM), or Flash). Storage 630 is generally included to be representative of a non-volatile memory, such as a hard disk drive, solid state device (SSD), removable memory cards, optical storage, or flash memory devices. In an alternative embodiment, storage 630 can be replaced by storage area-network (SAN) devices, the cloud, or other devices connected to computer 600 via I/O device interface 610 or network 650 via network interface 615.

In some embodiments, memory 625 stores instructions 660. However, in various embodiments, instructions 660 are stored partially in memory 625 and partially in storage 630, or they are stored entirely in memory 625 or entirely in storage 630, or they are accessed over network 650 via network interface 615.

Instructions 660 can be computer-readable and computer-executable instructions for performing any portion of, or all of, the methods of FIGS. 2 and/or 5 and/or implementing the functionality discussed with reference to any portion of FIGS. 1 and/or 3-4. Although instructions 660 are shown in memory 625, instructions 660 can include program instructions collectively stored across numerous computer-readable storage media and executable by one or more CPUs 605.

In various embodiments, I/O devices 612 include an interface capable of presenting information and receiving input. For example, I/O devices 612 can present information to a user interacting with computer 600 and receive input from the user.

Computer 600 is connected to network 650 via network interface 615. Network 650 can comprise a physical, wireless, cellular, or different network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

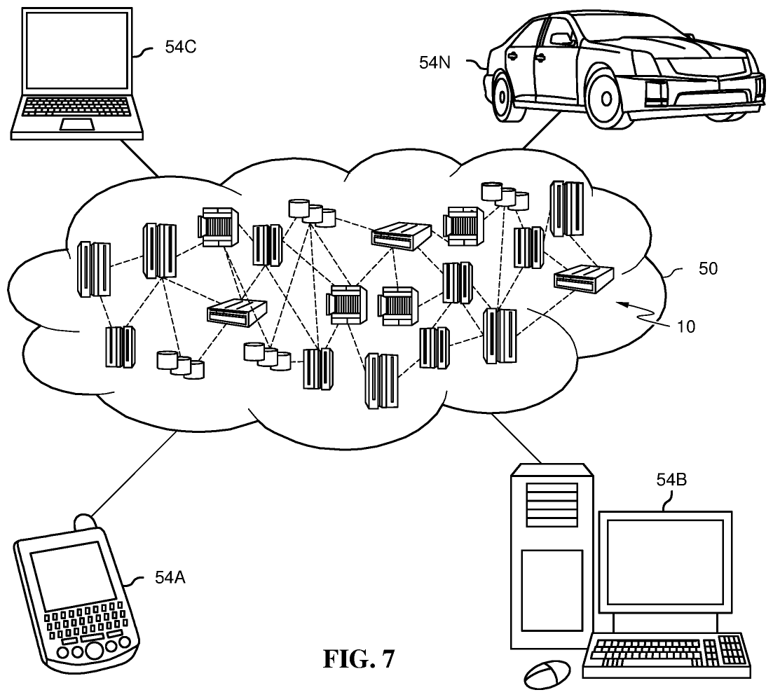

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

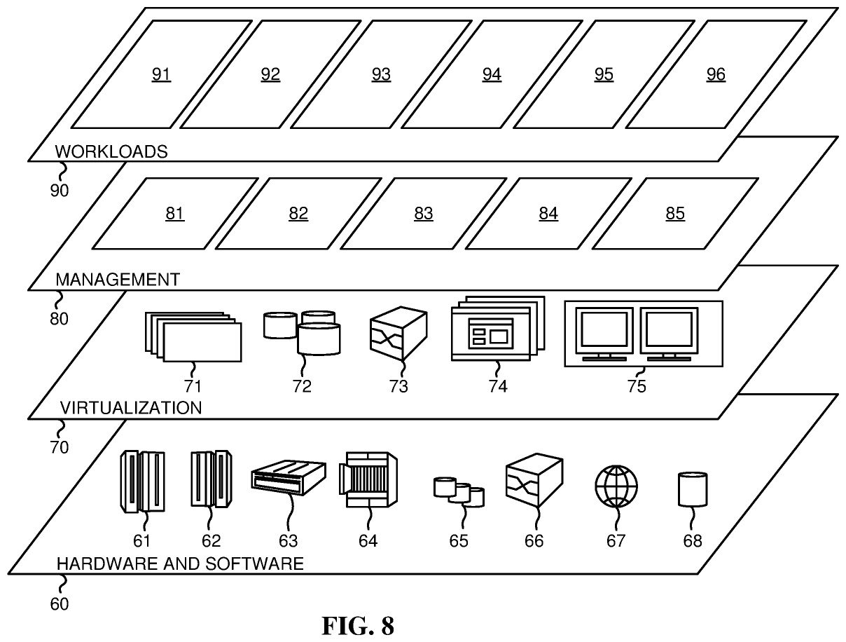

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and analytics using a dynamic ensemble model 96.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 660 of FIG. 6 and/or any software configured to perform any portion of the methods described with respect to FIGS. 2 and/or 5 and/or implement any portion of the functionality discussed with respect to FIGS. 1 and/or 3-4) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes training a plurality of machine learning models on training data; identifying a similar subset of the training data that is similar to a dataset for evaluation; assembling a subset of models from the plurality of machine learning models based on performance of the subset of models on the similar subset of the training data; and generating an output from the subset of models for the dataset for evaluation.

Example 2 includes the method of example 1, including or excluding optional features. In this example, the similar subset is similar based on a distance metric and a relative density metric. Optionally, the distance metric is based on a distance between one or more training data to one or more data of the dataset for evaluation. Optionally, the relative density metric is based on a density of data in the similar subset compared to a density of data in the training data.

Example 3 includes the method of any one of examples 1 to 2, including or excluding optional features. In this example, the similar subset is selected by selecting data that reduces a distance between one or more data in the training data to one or more data in the dataset for evaluation, and by decreasing a density of data points in the similar subset.

Example 4 includes the method of any one of examples 1 to 3, including or excluding optional features. In this example, the subset of models comprises a predetermined number of the plurality of machine learning models that exhibits a highest accuracy on the similar subset.

Example 5 includes the method of any one of examples 1 to 4, including or excluding optional features. In this example, the subset of models comprises any of the plurality of machine learning models that exhibits an accuracy above an accuracy threshold on the similar subset.

Example 6 includes the method of any one of examples 1 to 5, including or excluding optional features. In this example, the plurality of machine learning models comprises different types of machine learning models.

Example 7 includes the method of any one of examples 1 to 6, including or excluding optional features. In this example, the plurality of machine learning models comprises different hyperparameters applied in a similar machine learning algorithm.

Example 8 includes the method of any one of examples 1 to 7, including or excluding optional features. In this example, the method is performed by one or more computers according to software that is downloaded to the one or more computers from a remote data processing system. Optionally, the method further comprises: metering a usage of the software; and generating an invoice based on metering the usage.

Example 9 is a computer-implemented method. The method includes generating a training matrix including features for each of a plurality of training data; generating a model results matrix including outputs from a plurality of models for each of the plurality of training data; generating a scoring matrix by applying a sigmoid function to the model results matrix to generate a plurality of model scores for each of the plurality of training data; generating a ground truth matrix including a ground truth score based on the plurality of model scores for each of the plurality of training data; selecting a similar subset of training data that is similar to a dataset for evaluation; selecting, based on the scoring matrix and the ground truth matrix, a subset of models from the plurality of models with performance above a threshold for the similar subset of training data; and generating an output from the subset of models for the dataset for evaluation.

Example 10 includes the method of example 9, including or excluding optional features. In this example, the output is based on a weighted average of each of the subset of models, and wherein respective models in the subset of models are weighted according to a respective score from the scoring matrix.

Example 11 includes the method of any one of examples 9 to 10, including or excluding optional features. In this example, the similar subset of training data exhibits a lower distance to the dataset for evaluation than the training data, and wherein the similar subset of training data exhibits a lower density relative to the training data.

Example 12 includes the method of any one of examples 9 to 11, including or excluding optional features. In this example, the method is performed by one or more computers according to software that is downloaded to the one or more computers from a remote data processing system. Optionally, the method further comprises: metering a usage of the software; and generating an invoice based on metering the usage.

Example 13 is a system. The system includes one or more processors and one or more computer-readable storage media collectively storing program instructions. The one or more processors are configured to execute the program instructions to cause the one or more processors to perform a method according to any one of examples 1 to 12.

Example 14 is a computer program product. The computer program product includes one or more computer readable storage media, and program instructions collectively stored on the one or more computer readable storage media. The program instructions include instructions configured to cause one or more processors to perform a method according to any one of examples 1 to 12.

What is claimed is:

1. A computer-implemented method comprising:
training a plurality of machine learning models on training data;
identifying a similar subset of the training data that is similar to a dataset for evaluation;
assembling a subset of models from the plurality of machine learning models based on performance of the subset of models on the similar subset of the training data; and
generating an output from the subset of models for the dataset for evaluation.

2. The method of claim 1, wherein the similar subset is similar based on a distance metric and a relative density metric.

3. The method of claim 2, wherein the distance metric is based on a distance between one or more training data to one or more data of the dataset for evaluation.

4. The method of claim 2, wherein the relative density metric is based on a density of data in the similar subset compared to a density of data in the training data.

5. The method of claim 1, wherein the similar subset is selected by selecting data that reduces a distance between one or more data in the training data to one or more data in the dataset for evaluation, and by decreasing a density of data points in the similar subset.

6. The method of claim 1, wherein the subset of models comprises a predetermined number of the plurality of machine learning models that exhibits a highest accuracy on the similar subset.

7. The method of claim 1, wherein the subset of models comprises any of the plurality of machine learning models that exhibits an accuracy above an accuracy threshold on the similar subset.

8. The method of claim 1, wherein the plurality of machine learning models comprises different types of machine learning models.

9. The method of claim 1, wherein the plurality of machine learning models comprises different hyperparameters applied in a similar machine learning algorithm.

10. The method of claim 1, wherein the method is performed by one or more computers according to software that is downloaded to the one or more computers from a remote data processing system.

11. The method of claim 10, wherein the method further comprises:
metering a usage of the software; and
generating an invoice based on metering the usage.

12. A computer-implemented method comprising:
generating a training matrix including features for each of a plurality of training data;
generating a model results matrix including outputs from a plurality of models for each of the plurality of training data;
generating a scoring matrix by applying a sigmoid function to the model results matrix to generate a plurality of model scores for each of the plurality of training data;
generating a ground truth matrix including a ground truth score based on the plurality of model scores for each of the plurality of training data;
selecting a similar subset of training data that is similar to a dataset for evaluation;
selecting, based on the scoring matrix and the ground truth matrix, a subset of models from the plurality of models with performance above a threshold for the similar subset of training data; and
generating an output from the subset of models for the dataset for evaluation.

13. The method of claim 12, wherein the output is based on a weighted average of each of the subset of models, and wherein respective models in the subset of models are weighted according to a respective score from the scoring matrix.

14. The method of claim 12, wherein the similar subset of training data exhibits a lower distance to the dataset for evaluation than the training data, and wherein the similar subset of training data exhibits a lower density relative to the training data.

15. The method of claim 12, wherein the method is performed by one or more computers according to software that is downloaded to the one or more computers from a remote data processing system.

16. The method of claim 15, wherein the method further comprises:
metering a usage of the software; and
generating an invoice based on metering the usage.

17. A computer program product comprising one or more computer readable storage media, and program instructions collectively stored on the one or more computer readable storage media, the program instructions comprising instructions configured to cause one or more processors to perform a method comprising:
training a plurality of machine learning models on training data;
identifying a similar subset of the training data that is similar to a dataset for evaluation;
assembling a subset of models from the plurality of machine learning models based on performance of the subset of models on the similar subset of the training data; and
generating an output from the subset of models for the dataset for evaluation.

18. The computer program product of claim 17, wherein the similar subset is similar based on a distance metric and a relative density metric.

19. The computer program product of claim 17, wherein the plurality of machine learning models comprises different hyperparameters in a similar algorithm.

20. The computer program product of claim 17, wherein the subset of models comprises models selected from a group consisting of:
a predetermined number of the plurality of machine learning models that exhibits a highest accuracy on the similar subset; and
any of the plurality of machine learning models that exhibits an accuracy above an accuracy threshold on the similar subset.
